(19) United States
(12) Patent Application Publication
(10) Pub. No.: US 2020/0215727 A1
(43) Pub. Date: Jul. 9, 2020

(54) PROCESS FOR THE PRODUCTION OF A STRUCTURED GRAIN ON THE SURFACE OF A THERMOPLASTIC HAVING CONTINUOUS-FIBER REINFORCEMENT BY A TEXTILE SHEET

(71) Applicant: BASF SE, Ludwigshafen am Rhein (DE)

(72) Inventors: Tim DIEHLMANN, Ludwigshafen (DE); Andreas RADTKE, Ludwigshafen (DE); Ulrich SCHNEIDER, Ludwigshafen (DE); Reinhard JAKOBI, Ludwigshafen (DE)

(73) Assignee: BASF SE, Ludwigshafen am Rhein (DE)

(21) Appl. No.: 16/628,923

(22) PCT Filed: Jul. 19, 2018
(86) PCT No.: PCT/EP2018/069676

§ 371 Date: Jan. 6, 2020

(30) Foreign Application Priority Data
Jul. 31, 2017 (EP) 17184105.9

(51) Int. Cl. B29C 33/42; B29C 70/16; B29C 70/54; B29C 70/40

(52) U.S. Cl. CPC B29C 33/424; B29C 70/16; B29K 2101/12; B29C 70/40; B29C 70/54

(57) ABSTRACT

The present invention relates to a process for the production of a structured grain on the surface of a thermoplastic having continuous-fiber reinforcement by a textile sheet, where a mixture of at least one fiber material and of at least one thermoplastic is heated and pressed in a mold to a temperature above the softening point of the thermoplastic, where a structured grain has been applied on the internal side of the mold. The at least one fiber material comprises continuous fibers and takes the form of a regularly arranged textile sheet. The textile sheet and the structured grain on the internal side of the mold are oriented in relation to one another in a manner such that during the pressing procedure the textile sheet and the structured grain on the internal side of the mold are mutually superposed. After the pressing procedure, the mixture of the at least one fiber material and the at least one thermoplastic in the mold is cooled to a temperature below the softening point of the thermoplastic, with formation of the structured grain on the surface of the thermoplastic. The present invention further relates to a thermoplastic which has continuous-fiber reinforcement by a textile sheet and has a structured grain on the surface, and is obtained by the process of the invention.

The present invention relates to a process for the production of a structured grain on the surface of a thermoplastic having continuous-fiber reinforcement by a textile sheet, where a mixture of at least one fiber material and of at least one thermoplastic is heated and pressed in a mold to a temperature above the softening point of the thermoplastic, where a structured grain has been applied on the internal side of the mold. The at least one fiber material comprises continuous fibers and takes the form of a regularly arranged textile sheet. The textile sheet and the structured grain on the internal side of the mold are oriented in relation to one another in a manner such that during the pressing procedure the textile sheet and the structured grain on the internal side of the mold are mutually superposed. After the pressing procedure, the mixture of the at least one fiber material and the at least one thermoplastic in the mold is cooled to a temperature below the softening point of the thermoplastic, with formation of the structured grain on the surface of the thermoplastic. The present invention further relates to a thermoplastic which has continuous-fiber reinforcement by a textile sheet and has a structured grain on the surface, and is obtained by the process of the invention.

Components made of fiber-reinforced thermoplastics are of great interest in particular for lightweight applications in aerospace, or in the automobile sector, because they exhibit high energy absorption and specific stiffness, and also strength together with comparatively low weight, and have good formability and good shelf life. The strength and stiffness here are particularly determined by the nature and arrangement of the supportive fiber material. The thermoplastic in these components serves as supportive matrix for the fiber material, and protects the fiber material from exterior physical and chemical effects.

However, the use in the visible region of a vehicle is problematic for components made of fiber-reinforced thermoplastics because the fiber material results in uneven surface texture which therefore fails to meet the quality requirements placed upon the component.

By way of example, M. Blinzler discloses in “Oberflächentexturen bei gewebeverstärkten Thermoplasten” [Surface textures in textile-reinforced thermoplastics], Kunststoffe 11/1999, pp. 128-130 that textile reinforcement of a thermoplastic produces a clearly visible texture on the surface; although painting EB16-1206PC Jul. 19, 2018 provides high gloss to said texture, at the same time it further increases the visibility of the surface irregularity.

Because the distribution of fiber material and thermoplastic material in fiber-reinforced thermoplastics is non-uniform, their surfaces also generally reveal the locations of the fibers. Other surface defects moreover arise from the shrinkage of the thermoplastic material, which is higher than that of the fiber material upon cooling.

In “Werkstoff-und prozessseitige Einflussmöglichkeiten zur Optimierung der Oberflächenqualität endlosfaserverstärkter Kunststoffe” [Possible influences of materials and processes in optimizing the surface quality of continuous-fiber-reinforced plastics], Dissertation, TU Kaiserslautern, 2002, pp. 12, 13, 46, 47, 120 and 121, M. Blinzler discloses various procedures for outer layers on painted components made of continuous-fiber-reinforced plastics, an example being increase of the proportion of thermoplastic in the external layer of the component via reduction of the content of fiber material, application of an external layer without affecting the interior region of the thermoplastic component, increase of the layer thickness of the paint system via additional filler layers or increased quantity of topcoat applied, or application of a dry-paint film.

The abovementioned problems relating to the frequently unsatisfactory surface quality of fiber-reinforced thermoplastics, and procedures for improvement of same are disclosed inter alia on the Internet page www.maschinenmarkt.vogel.de/faser verstaerkte-thermoplaste-mit-entwicklungsansaetzen-fuer-class-a-faehige-oberflaechen-a-814/, retrieved on Dec. 14, 2016.

The object of the present invention is therefore to provide an improved process which avoids the disadvantages described in the prior art.

Said object has been achieved via a process for the production of a structured grain on the surface of a thermoplastic having continuous-fiber reinforcement by a textile sheet, comprising the steps a) to c):
a) heating of a mixture of at least one fiber material and at least one thermoplastic to a temperature above the softening point of the thermoplastic, where the at least one fiber material comprises continuous fibers and takes the form of a regularly arranged textile sheet,
b) pressing, in a mold, of the mixture heated in step a), where a regularly arranged, structured grain has been applied on the internal side of the mold,
c) cooling, in the mold, of the mixture pressed in step b) to a temperature below the softening point of the thermoplastic, with formation of the structured grain on the surface of the thermoplastic having continuous-fiber reinforcement by the textile sheet,
   where the structured grain on the internal side of the mold and the textile sheet in the mold have been oriented in relation to one another in step b) in a manner such that the regularly arranged textile sheet and the regularly arranged structured grain on the internal side of the mold are mutually superposed.

The process of the invention can apply, to the surface of thermoplastics having continuous-fiber reinforcement by a textile sheet, a structured grain which improves the perceived quality of the surface because as a result of the structured grain the surface is no longer perceived to be uneven. The structured grain on the surface of the continuous-fiber-reinforced thermoplastics can moreover be achieved in a simple manner, and has the result that it is no longer essential to use other surface treatments. The structured grain can effectively cover defects on the surface of the continuous-fiber-reinforced thermoplastics, the aim here being to achieve a significant improvement in the appearance of the continuous-fiber-reinforced thermoplastics.

The present invention is explained in detail below.

For the purposes of the present invention, the expression “structured grain” means structuring patterns, i.e. regularly arranged structured depressions and/or elevations, on a surface. A structuring pattern is composed of at least one structure unit.

For the purposes of the present invention, the expression “structure unit” means the smallest unit in a structuring pattern. A structure unit usually comprises a defined number of depressions and/or elevations of any desired geometry which have regular arrangement within themselves and/or in relation to other structure units in the structuring pattern. This type of structure unit can by way of example comprise diamond shapes, rhombi, rectangles, squares or lines. It is optionally possible that structure units alternate and/or are combined with one another. It is therefore possible to conceive of patterns composed of a plurality of various lines of different thickness (width) and/or depth.

For the purposes of the present invention, the expression “regularly arranged” describes units which are repeated with defined spacings, preferably being arranged in accordance with a definite pattern. These units can be structure units in the structured grain or repeating units in textile sheets.

The distances between the individual structure units of a structured depression on a surface can assume any desired valves (magnitudes), for example 300 μm. It is preferable that the distance between the individual structure units of the structured depressions is at most 1200 μm (average value across the entire pattern), the distance in particular being from 50 to 1200 μm. The width of a structure unit, for example the diameter of a point (in a punctiform structure) or the width of a line (in a linear or lattice-type structure) can be as desired, preferably being in the range from 60 to 800 μm, more preferably from 70 to 600 μm, in particular from 80 to 400 μm.

The values (magnitudes) assumed by the depressions per se (i.e. the structuring depth) can likewise be as desired. It is therefore possible that subregions of a surface comprise structure units/patterns that are identical but differ in respect of their depth.

The magnitude (depth) of the depressions (in terms of average value) is very generally not more than 25% of the thickness of the fiber-reinforced thermoplastic, but this value can also optionally be somewhat higher.

In step a) of the process of the invention, a mixture of at least one fiber material and at least one thermoplastic is heated to a temperature above the softening point of the thermoplastic, where the at least one fiber material comprises continuous fibers and takes the form of a regularly arranged textile sheet.

The mixture of the at least one fiber material and the at least one thermoplastic can in principle take any desired form that appears to the person skilled in the art to be appropriate. The mixture of the at least one fiber material and the at least one thermoplastic is usually a fiber-composite material in which the at least one fiber material takes the form of continuous fibers and the at least one thermoplastic takes the form of polymeric matrix surrounding the at least one fiber material. Corresponding (continuous-)fiber-composite materials are well known to the person skilled in the art.

For the purposes of the present invention, the expressions “thermoplastic having continuous-fiber reinforcement by a textile sheet” and “continuous-fiber-reinforced thermoplastic” are used synonymously.

The mixture of the at least one fiber material and the at least one thermoplastic preferably takes the form of semifinished product. For the purposes of the present invention, the expression “semifinished product” means a starting material in sheet form for thermoforming processes, comprising a core made of a textile sheet. The semifinished product preferably takes the form of extruded films, profiles or sheets, particularly preferably taking the form of semifinished sheet.

The surface of this type of semifinished product will normally be very substantially flat, but it is also possible, as required by a particular application, that the surface has curvature.

The thickness of the semifinished product is preferably in the range from 0.1 to 50 mm, more preferably in the range from 0.5 to 25 mm and particularly preferably in the range from 1 to 4 mm.

In the context of the present invention, the expression “at least one fiber material” means precisely one fiber material or else a mixture of two or more different fiber materials. It is in principle possible in the invention to use, as fiber material, any of the fiber materials known to the person skilled in the art.

In the invention, the at least one fiber material comprises continuous fibers. The terms “continuous fiber” and “filament” are used synonymously for the purposes of the present invention. For the purposes of the present invention, the term “continuous fiber” means fibers which, in respect of their length, are uninterrupted in the mixture of the at least one fiber material and the at least one thermoplastic.

The at least one fiber material preferably comprises at least 50% by weight, more preferably at least 75% by weight, still more preferably at least 85% by weight, particularly preferably at least 98% by weight, and very particularly preferably 100% by weight, based in each case on the total weight of the at least one fiber material, of continuous fibers.

The at least one fiber material preferably comprises glass fibers, natural fibers, synthetic fibers, aramid fibers, carbon fibers, metal fibers, for example steel fibers or copper fibers, mineral fibers, for example basalt fibers, boron fibers, potassium titanate fibers, or a combination thereof. Particular preference is given to glass fibers or carbon fibers.

The fiber diameter of the at least one fiber material is preferably in the range from 1 to 100 μm, more preferably in the range from 5 to 50 μm and particularly preferably in the range from 7 to 30 μm.

The at least one fiber material takes the form of a regularly arranged textile sheet. For the purposes of the present invention, the expression “textile sheet” means by way of example sheet-like materials produced from textile materials such as fibers or filaments. Regularly arranged textile sheets have units which are repeated with defined spacings, preferably being arranged in accordance with a definite pattern. Textile sheets of this type are known in principle to the person skilled in the art.

Regularly arranged textile sheets usually feature an oriented structure in which the at least one fiber material is oriented on a defined number of orientation directions. In particular, regularly arranged textile sheets do not have the irregular and unordered fibers found by way of example in nonwoven fabric or in felt.

It is preferable that the regularly arranged textile sheet is a woven fiber fabric, laid fiber scrim, knitted fiber fabric or braided fiber fabric, or takes the form of a unidirectional or bidirectional fiber structure made of parallel fibers.

The textile sheet is particularly preferably a woven fiber fabric or a laid fiber scrim, very particularly a woven fiber fabric.

The woven fiber fabric used can in principle be any desired woven fiber fabric. Preferred types of woven fabric comprise plain weave, twill weave or satin weave. Woven fiber fabrics in twill weave are more preferably used.

The linear density of the at least one fiber material is preferably in the range from 100 to 10 000 tex, more preferably in the range from 400 to 5000 tex and particularly preferably in the range from 800 to 2000 tex.

The structure density of the at least one fiber material is moreover preferably in the range from 1 to 10 rovings/cm, more preferably in the range from 1.5 to 5 rovings/cm and very particularly preferably in the range from 2 to 4 rovings/cm.

The at least one fiber material can be composed of one or more plies of textile sheets. The at least one fiber material is preferably composed of at least one and at most 30 plies, more preferably at least two plies and at most 10 plies, particularly preferably at least two plies and at most five plies of textile sheets.

If plies of parallel-oriented fibers are used at an angle to one another, it is preferable that the individual plies have a bidirectional structure and that the angle between each is 90°. When three plies, or a multiple of three plies, is/are used, it is also possible to arrange the individual plies at an angle of 60° to one another, and in the case of four plies, or multiples of four plies, the individual plies can be arranged at an angle of 45° to one another.

It is moreover also possible to provide more than one ply of fibers with identical orientation. It is likewise possible here that plies are at an angle to one another, and the number of plies here with fibers of identical orientation in each of the orientations of the fibers can be different, an example being four plies in a first direction and one ply in a direction at an angle thereto, for example 90° (bidirectional structure with preferential direction). There is moreover also a known quasi-isotropic structure in which the fibers of a second ply are arranged at an angle of 90° to the fiber of a first ply and moreover fibers of a third ply are arranged at an angle of 45° to the fibers of the second ply.

The weight per unit area of each ply of the at least one fiber material is preferably in the range from 100 to 1000 g/m², more preferably in the range from 200 to 800 g/m² and very particularly preferably in the range from 500 to 700 g/m² auf.

In a particularly preferred embodiment, the linear density of the textile sheet is in the range from 800 to 2000 tex and its structural density is in the range from 2 to 4 rovings/cm, and the weight per unit area of each ply of the textile sheet is in the range from 500 to 700 g/m².

In a very particularly preferred embodiment, the textile sheet is a woven fiber fabric made of glass fibers with fiber diameter in the range from 10 to 30 μm in 2/2 twill weave, linear density in the range from 800 to 2000 tex and structural density in the range from 2 to 4 rovings/cm, the weight per unit area of each ply of the textile sheet being in the range from 500 to 700 g/m².

The mixture of the at least one fiber material and the at least one thermoplastic preferably comprises at least 20% by volume of the at least one fiber material, based on the total volume of the mixture, particularly preferably at least 45% by volume.

The mixture of the at least one fiber material and the at least one thermoplastic moreover comprises at most 80% by volume of the at least one fiber material, based on the total volume of the mixture, preferably at most 60% by volume.

In a preferred embodiment, the mixture of the at least one fiber material and the at least one thermoplastic comprises from 20 to 80% by volume of the at least one fiber material, based on the total volume of the mixture, preferably from 45 to 60% by volume, where the total volume of the mixture always provides 100% by volume.

The mixture moreover comprises at least one thermoplastic. The expression “at least one thermoplastic” in the context of the present invention means precisely one thermoplastic or else a mixture of two or more different thermoplastics. Thermoplastic used in the invention can in principle be any thermoplastic known to the person skilled in the art.

For the purposes of the present invention, the term “thermoplastic” means polymeric plastics which are amenable to (thermoplastic) deformation within a definite temperature range. This process is in principle reversible, i.e. it can be repeated many times by cooling and reheating to the molten state.

It is preferable that the at least one thermoplastic is a heat-resistant thermoplastic with softening point above 100° C.

It is preferable that the at least one thermoplastic is selected from polyolefins, polyvinyl polymers, styrene polymers, styrene-acrylonitrile copolymers, acrylonitrile-butadiene-styrenes (ABS), polymers of (meth)acrylic acid, polyacrylates, polymethyl methacrylates, polyacrylamides, polycarbonates, polyalkylene oxides, polyphenylene ethers, polyphenylene sulfides, polyether sulfones, polyether ketones, polyimides, polyquinoxalines, polyquinolines, polybenzimidazoles, polyamides, polyesters, polyurethanes, polyisocyanates, polyols, polyether polyols, polyester polyols and mixtures thereof.

Suitable polyolefins comprise by way of example polyethylene (PE), polypropylene (PP), polybutylene (PB) and halogenated polyolefins such as polytetrafluoroethylene.

Polyvinyl polymers suitable for the process of the invention comprise by way of example polyvinyl halides, polyvinyl acetates, polyvinyl ethers, polyvinyl alcohols, polyvinyllactams and polyvinylamines.

Examples of suitable polyacrylates are polymers of the alkyl esters, alkali and alkaline earth metals of acrylic acid and of methacrylic acid.

Polyalkylene oxides comprise by way of example polyoxymethylene (POM) and polyethylene glycols (PEG).

Suitable polyamides comprise by way of example polyamide 4.6, polyamide 6, polyamide 6.6, polyamide 6.10, polyamide 6.12, polyamide 10.10, polyamide 11, polyamide 12, polyamide 12.12, polyamide 13.13, polyamide 66, polyamide 6.T, polyamide 9.T, polyamide MXD.6, polyamide 6/6.6, polyamide 6/6.T, polyamide 6.1/6.T, polyamide 6/6.6/6.10 and mixtures thereof.

Polyesters suitable for the process of the invention comprise by way of example aliphatic polyesters, and also aromatic polyesters such as polyethylene terephthalate (PET) and polybutylene terephthalate (PBT).

It is particularly preferable that the at least one thermoplastic is selected from polyethylene (PE), polypropylene (PP), polyoxymethylene (POM), polyethylene terephthalate (PET), polybutylene terephthalate (PBT), acrylonitrile-butadiene-styrene (ABS), polyamide 4.6, polyamide 6, polyamide 6.6, polyamide 6.10, polyamide 6.12, polyamide 10.10, polyamide 11, polyamide 12, polyamide 12.12, polyamide 13.13, polyamide 66, polyamide 6.T, polyamide 9.T, polyamide MXD.6, polyamide 6/6.6, polyamide 6/6.T, polyamide 6.1/6.T, polyamide 6/6.6/6.10 and mixtures thereof.

It is very particularly preferable that the at least one thermoplastic is selected from polyamide 4.6, polyamide 6, polyamide 6.6, polyamide 6.10, polyamide 6.12, polyamide 10.10, polyamide 11, polyamide 12, polyamide 12.12, polyamide 13.13, polyamide 66, polyamide 6.T, polyamide 9.T, polyamide MXD.6, polyamide 6/6.6, polyamide 6/6.T, polyamide 6.1/6.T, polyamide 6/6.6/6.10 and mixtures thereof.

The mixture of the at least one fiber material and the at least one thermoplastic preferably comprises at least 20% by volume of the at least one thermoplastic, based on the total volume of the mixture, particularly preferably at least 40% by volume.

The mixture of the at least one fiber material and the at least one thermoplastic moreover comprises at most 80% by volume of the at least one thermoplastic, based on the total volume of the mixture, preferably at most 55% by volume.

In a preferred embodiment, the mixture of the at least one fiber material and the at least one thermoplastic comprises from 20 to 80% by volume of the at least one thermoplastic, based on the total volume of the mixture, preferably from 45 to 55% by volume, where the total volume of the mixture always provides 100% by volume.

The mixture of the at least one fiber material and the at least one thermoplastic, can additionally comprise additives in order to adjust the properties of the continuous-fiber-reinforced thermoplastic onto which the regularly arranged structured grain is applied. For the purposes of the present invention, all embodiments in which reference is made to a mixture of the at least one fiber material and the at least one thermoplastic also comprise mixtures which also comprise additives alongside the at least one fiber material and the at least one thermoplastic.

Suitable additives comprise by way of example stabilizers, lubricants, nucleating agents, dyes, hardeners, plasticizers, and blends with other polymers; they also comprise any desired other additives known to the person skilled in the art.

Suitable stabilizers comprise by way of example sterically hindered phenols, secondary aromatic amines, hydroquinones, resorcinols, vitamin E and compounds structurally similar thereto, copper(l) halides, nickel-containing free-radical scavengers, triazines, benzoxazinones, benzotriazoles, benzophenones, benzoates, formamidines, propenoates, aromatic propanediones, benzimidazoles, cycloaliphatic ketones, formanilides, cyanoacrylates, benzopyranones and salicylates.

Lubricants comprise by way of example stearic acids, stearyl alcohols, stearyl esters, ethylenebis(stearamide) (EBS), higher fatty acids and derivatives of these, and also fatty acid mixtures with fatty acids having from 12 to 30 carbon atoms, silicone oils, oligomeric isobutylene and similar compounds.

Suitable nucleating agents comprise by way of example sodium phenylphosphinates, aluminum oxides, silicon oxides, nylon-2.2 and talc.

The following can be used by way of example as colorants: organic dyes such as nigrosin, or pigments such as ultramarine blue, phthalocyanines, titanium dioxide, cadmium sulfides, cadmium selenides, pigment black, or derivatives of perylenetetracarboxylic acid.

Plasticizers comprise by way of example dioctyl phthalates, dibenzyl phthalates, butyl benzyl phthalates, N-(n-butyl)benzylsulfonamide, ortho- and para-tolylethylsulfon-amides or hydrocarbon-containing oils.

The proportion of the at least one additive in the mixture of the at least one fiber material and the at least one thermoplastic is preferably from 0 to 10% by volume, particularly preferably from 0 to 5% by volume, based on the total volume of the mixture.

In a preferred embodiment, the mixture of the at least one fiber material and the at least one thermoplastic comprises

from 20 to 80% by volume of the at least one thermoplastic,
from 20 to 80% by volume of the at least one fiber material, and
from 0 to 10% by volume of other additives,
where the total volume of the mixture always provides 100% by volume.

In an embodiment to which preference is further given, the mixture of the at least one fiber material and the at least one thermoplastic comprises

from 40 to 55% by volume of the at least one thermoplastic,
from 45 to 60% by volume of the at least one fiber material, and
from 0 to 5% by volume of other additives,
where the total volume of the mixture always provides 100% by volume.

The mixture of the at least one fiber material and the at least one thermoplastic can be produced in, in principle, any desired manner by the process known to the person skilled in the art. By way of example, the fiber material can be saturated with the at least one thermoplastic to produce the mixture of the at least one fiber material and the at least one thermoplastic.

Alternatively to the above, the fiber material can also be saturated with monomers for the production of the at least one thermoplastic, and the monomers are then polymerized, for example by heating, to produce the mixture of the at least one fiber material and the at least one thermoplastic. Monomers suitable for the production of the at least one thermoplastic are known in principle to the person skilled in the art.

Other possible methods for the production of the mixture of the at least one fiber material and the at least one thermoplastic comprise by way of example a powder impregnation procedure, the lamination of the at least one fiber material with thermoplastic films, or the mixing of the at least one fiber material with thermoplastic fibers and then melting and pressing of the polymer films and/or of the thermoplastic fibers.

In step a), the mixture of the at least one fiber material and the at least one thermoplastic is heated to a temperature above the softening point of the at least one thermoplastic.

For the purposes of the present invention, the expression “softening point” means the temperature or temperature range at which amorphous or (semi)crystalline thermoplastics change from the glassy or energy-elastic state to a molten or rubbery-elastic state. This change is associated with a reduction of the hardness of appropriate materials. In the case of (semi)crystalline thermoplastics, the softening point corresponds to the melting point or melting range of the thermoplastic. In the case of amorphous thermoplastics, the softening point corresponds to the glass transition temperature or glass transition range of the amorphous thermoplastics.

Any desired method known to the person skilled in the art can be used to heat the mixture of the at least one fiber material and the at least one thermoplastic.

The mixture of the at least one fiber material and the at least one thermoplastic can preferably be heated to a temperature above the softening point of the thermoplastic in the mold in which step b) of the process of the invention is also carried out.

Alternatively to the above, the mixture of the at least one fiber material and the at least one thermoplastic can also initially be heated to a temperature above the softening point of the thermoplastic in a separate device, the heated mixture then being transferred into the mold for the pressing procedure according step b).

It is moreover also possible that the mixture of the at least one fiber material and the at least one thermoplastic is initially preheated to a temperature below the softening point of the at least one thermoplastic in a separate device, and that the mixture is then transferred into the mold in which step b) of the process of the invention is also carried out, where the mixture in the mold is heated to a temperature above the softening point of the at least one thermoplastic.

If the mixture is heated before insertion into the mold, the heating preferably takes place in an oven, particularly preferably in a convection oven, or by means of infrared radiation.

It is preferable that the mixture of the at least one fiber material and the at least one thermoplastic is heated in step a) to a temperature which is above the softening point of the at least one thermoplastic by at least 5° C., more preferably at least 10° C. and with particular preference at least 15° C.

If the at least one thermoplastic is a mixture of two or more different thermoplastics, the mixture of the at least one fiber material and the at least one thermoplastic is preferably heated in step a) to a temperature above the softening point of the thermoplastic with the highest softening point.

The mixture of the at least one fiber material and the at least one thermoplastic is preferably heated to a temperature in the range from 100° to 450° C., more preferably in the range from 120° to 400° C. and particularly preferably in the range from 140° to 350° C.

In step b), the mixture heated in step a) is pressed in a mold, where a regularly arranged structured grain has been applied on the internal side of the mold.

The mold used in the process of the present invention is known per se to the person skilled in the art. It is preferably a combined press/injection molding in which by way of example it is possible to carry out not only a molding (pressing) procedure, but also a heating procedure, and a procedure for molding-on of an injected material (for example a polyamide). To this end, the mold can have not only cavities to receive the mixture of the at least one fiber material and the at least one thermoplastic but also cavities to receive an injection-molding polymer. This type of mold preferably has a plurality of such cavities.

Pressing per se is known to the person skilled in the art. During the pressing procedure, exposure to pressure changes the geometry of the continuous-fiber-reinforced thermoplastic, for example through bending to the maximum extent or at least to some extent. The geometry of the continuous-fiber-reinforced thermoplastic resulting from step b) is determined by the shape of the mold.

The pressing procedure in step b) is preferably carried out with a pressure of at least 3 bar absolute, more preferably at least 5 bar absolute and particularly preferably at least 10 bar absolute.

In a preferred embodiment, step b) is carried out with a pressure in the range from 3 to 50 bar absolute, more preferably from 5 to 30 bar absolute and particularly preferably from 10 to 25 bar absolute.

The temperature in step b) is preferably in a range from 100° C. to 450° C., preferably from 120° C. to 400° C. and with particular preference from 140° C. to 350° C. The press procedure can further increase the temperature of the mixture of the at least one fiber material and the at least one thermoplastic.

If the mixture of the at least one fiber material and the at least one thermoplastic has been heated in the mold in step a), the temperature used for the pressing in step b) is preferably the same as in step a).

The pressing procedure in step b) is the actual manufacturing step for the production of the structured grain on the surface of the continuous-fiber-reinforced thermoplastic. The thickness of the continuous-fiber-reinforced thermoplastic is preferably adjusted in step b) to a range of from 0.1 mm to 10 mm, more preferably from 0.5 mm to 3 mm; alternatively, downstream of step b) there is a further step in which the thickness of the finished part is adjusted by pressing to a range of from 0.5 to 10 mm, more preferably from 0.5 mm to 3 mm.

The internal side of the mold used in the process of the invention has a regularly arranged structured grain. The structured grain has been applied on the internal side of the mold wall, and the shape of the structured grain on the internal side of the mold is therefore cast by the pressing procedure onto the surface of the continuous-fiber-reinforced thermoplastic; it is preferable that the shape of the structured grain is fully cast onto the surface of the thermoplastic having continuous-fiber reinforcement by the textile sheet.

It is clear to the person skilled in the art that the structured grain on the internal side of the mold has been structured via depressions and/or elevations in order to permit casting onto the surface of the continuous-fiber-reinforced thermoplastic. If, by way of example, the intention is to provide a circular depression to the surface of the continuous-fiber-reinforced thermoplastic, the internal side of the mold must have a structured grain analogous thereto in the form of an elevation, and vice versa.

In principle, any desired methods can be used to apply the structured grain on the internal side of the mold. The structured grain is preferably produced in the mold via etching, laser structuring, sandblasting, profile milling or erosion, as a result of which the internal side of the mold has a surface with depressions and/or elevations.

The structured grain on the internal side of the mold preferably produces, on the surface of the thermoplastic having continuous-fiber reinforcement by the textile sheet, a structured grain in the form of a structuring pattern composed of at least one structure unit. The structured grain on the internal side of the mold can in principle produce any desired structuring patterns on the surface of the continuous-fiber-reinforced thermoplastics.

The regularly arranged structured grain is preferably applied onto the internal side of the mold in a manner such that a structured grain is produced on the visible side of the continuous-fiber-reinforced thermoplastic.

The regularly arranged structured grain on the internal side of the mold and the textile sheet in the mold have been oriented in relation to one another in step b) in the invention in a manner such that the regularly arranged textile sheet and the regularly arranged structured grain on the internal side of the mold are mutually superposed. It is preferable that the regularly arranged textile sheet and the regularly arranged structured grain on the internal side of the mold are thus fully mutually superposed.

It is clear to the person skilled in the art here that the manner of orientation to one another of the textile sheet and the regularly arranged structured grain on the internal side of the mold in step b) is preferably such that the desired structured grain on the surface of the continuous-fiber-reinforced thermoplastic is present on the visible side thereof. In regions of the continuous-fiber-reinforced thermoplastic that during subsequent use, for example as components in vehicles, are not in the visible region, it is not essential to achieve superposition of the textile sheet and the structured grain on the internal side of the mold.

The surface of the continuous-fiber-reinforced thermoplastic usually has unevenness which is caused by the textile sheet and which takes the form of elevations and depressions that are to be covered by the structured grain on the surface of the continuous-fiber-reinforced thermoplastic.

It is therefore preferable that the textile sheet in the mold and the regularly arranged structured grain on the internal side of the mold are oriented in relation to one another in step b) in a manner such that the structured grain on the internal side of the mold is superposed to the greatest possible extent onto the uneven features on the surface of the continuous-fiber-reinforced thermoplastic. Elevations and/or depressions are cast in step b) onto the surface of the continuous-fiber-reinforced thermoplastic in a manner dependent on the structuring pattern of the regularly arranged structured grain on the internal side of the mold.

In step c), the mixture pressed in step b) is cooled in the mold to a temperature below the softening point of the thermoplastic, with formation of the structured grain on the surface of the thermoplastic having continuous-fiber reinforcement by the textile sheet.

The cooling in step c) can take place by any of the methods known to the person skilled in the art. By way of example, the cooling can take place by means of internal cooling within the mold, or the mixture pressed in step b) is cooled slowly in that no further heating of the mold to temperatures above the softening point of the thermoplastic is carried out.

It is preferable that in step c) the continuous-fiber-reinforced thermoplastic is fully hardened, but it is also optionally possible that a continuous-fiber-reinforced thermoplastic that is only partially hardened is removed from the mold after the pressing procedure. The person skilled in the art also uses the term “demolding” for the removal of the continuous-fiber-reinforced thermoplastic from the mold.

The temperature of the mold during demolding here can in principle assume any desired values, with the proviso that the temperature is below the softening point of the continuous-fiber-reinforced thermoplastic.

It is preferable that the mixture pressed in step b) is cooled in the mold to a temperature that is below the softening point of the at least one thermoplastic by at least 5° C., more preferably at least 10° C. and with particular preference at least 15° C.

If the at least one thermoplastic is a mixture of two or more different thermoplastics, the mixture of the at least one fiber material and the at least one thermoplastic is preferably cooled in step a) to a temperature that is below the softening point of the thermoplastic with the lowest softening point.

The mixture pressed in step b) is preferably heated to a temperature in the range from −20° to 40° C., more preferably in the range from 0° to 35° C. and particularly preferably in the range from 10° to 30° C.

Further steps can optionally be carried out after demolding, for example further processing of the continuous-fiber-reinforced thermoplastic as required by the desired use.

The structured grain on the surface of the continuous-fiber-reinforced thermoplastic is preferably composed of repeating and regularly arranged structure units which can have various arrangements as required.

The structured grain of the invention on the surface of the continuous-fiber-reinforced thermoplastic is preferably in particular not an irregularly arranged grain such as is encountered by way of example in leather.

The structuring pattern of the structured grain on the surface of the continuous-fiber-reinforced thermoplastic can comprise structure units that can in principle have any desired number of elevations and/or depressions.

The structuring pattern of the structured grain on the surface of the continuous-fiber-reinforced thermoplastic can by way of example comprise regularly arranged structure units having elevations.

The structuring pattern of the structured grain on the surface of the continuous-fiber-reinforced thermoplastic can moreover comprise regularly arranged structure units having depressions.

It is also possible moreover to conceive structuring patterns which comprise regularly arranged structure units having elevations and depressions.

In one embodiment, the configuration of the structure units of at least two adjacent structuring patterns of the structured grain on the surface of the continuous-fiber-reinforced thermoplastic is such that the arrangement of all of the structure units of one of the structuring patterns is inverted in relation to the structure units of the adjacent structuring pattern with the result that the surface reflections produced on viewing in daylight or under artificial lighting create, for the observer, the perception of a difference in height between adjacent groups.

It is preferable in this embodiment that each (first) structuring pattern of the structured grain on the surface of the continuous-fiber-reinforced thermoplastic adjoins a plurality of the adjacent other structuring patterns, and that all of the structure units of each adjacent structuring pattern are arranged with inversion in relation to the structure units of the (first) structuring pattern. It is thus possible to produce regular, macroscopic patterns and structures, for example a chessboard pattern or a grid-based pattern not involving in-register repetition.

It is further preferable that in this embodiment the transitions between adjacent structuring patterns of the structured grain on the surface of the continuous-fiber-reinforced thermoplastic run through the structure units per se, and that, by virtue of the abrupt inversion of the individual elements, the transition associated with each structuring pattern forms a distinctly visible edge between the structuring patterns.

It is also equally conceivable that in this embodiment the transitions between adjacent structuring patterns of the structured grain on the surface of the continuous-fiber-reinforced thermoplastic run through the structure units per se, and that the transitions between the structuring patterns are continuous.

For the purposes of the present invention, the expression “continuous transition” means a transition between two or more structuring patterns where the naked eye cannot discern any boundary between the structuring patterns.

In one embodiment, before step a), a thermoplastic film is applied to the mixture of the at least one fiber material and the at least one thermoplastic.

The thickness of the thermoplastic film can in principle be as desired. The thickness of the thermoplastic film is generally selected in a manner such that unevenness on the surface of the continuous-fiber-reinforced thermoplastic is no longer discernible. The thickness of the thermoplastic film is preferably in the range from 40 to 250 μm, particularly preferably in the range from 50 to 150 μm.

The thermoplastic film preferably comprises at least one thermoplastic selected from polyolefins, polyvinyl polymers, styrene polymers, styrene-acrylonitrile copolymers, acrylonitrile-butadiene-styrenes (ABS), polymers of (meth)acrylic acid, polyacrylates, polymethyl methacrylates, polyacrylamides, polycarbonates, polyalkylene oxides, polyphenylene ethers, polyphenylene sulfides, polyether sulfones, polyether ketones, polyimides, polyquinoxalines, polyquinolines, polybenzimidazoles, polyamides, polyesters, polyurethanes, polyisocyanates, polyols, polyether polyols, polyester polyols and mixtures thereof.

It is particularly preferable that the thermoplastic film comprises at least one thermoplastic selected from polyethylene (PE), polypropylene (PP), polyoxymethylene (POM), polyethylene terephthalate (PET), polybutylene terephthalate (PBT), acrylonitrile-butadiene-styrene (ABS), polyamide 4.6, polyamide 6, polyamide 6.6, polyamide 6.10, polyamide 6.12, polyamide 10.10, polyamide 11, polyamide 12, polyamide 12.12, polyamide 13.13, polyamide 66, polyamide 6.T, polyamide 9.T, polyamide MXD.6, polyamide 6/6.6, polyamide 6/6.T, polyamide 6.1/6.T, polyamide 6/6.6/6.10 and mixtures thereof.

It is very particularly preferable that the thermoplastic film comprises at least one thermoplastic selected from polyamide 4.6, polyamide 6, polyamide 6.6, polyamide 6.10, polyamide 6.12, polyamide 10.10, polyamide 11, polyamide 12, polyamide 12.12, polyamide 13.13, polyamide 66, polyamide 6.T, polyamide 9.T, polyamide MXD.6, polyamide 6/6.6, polyamide 6/6.T, polyamide 6.1/6.T, polyamide 6/6.6/6.10 and mixtures thereof.

It is preferable that the thermoplastic film comprises the same thermoplastics as the mixture of the at least one fiber material and the at least one thermoplastic.

The thermoplastic film can moreover comprise other additives. Suitable additives are generally well known to the person skilled in the art and comprise the additives that can also be comprised in the mixture of the at least one fiber material and the at least one thermoplastic.

The melt viscosity of the thermoplastic film can in principle be as desired. However, it is preferable that the melt viscosity of the thermoplastic film is higher than the melt viscosity of the at least one thermoplastic in the mixture heated in step a).

For the purposes of the present invention, the expression “melt viscosity” means the viscosity in the molten phase of the thermoplastic at the softening point of the thermoplastic. Determination of melt viscosity is known in principle to the person skilled in the art and is achieved by way of example in accordance with DIN 53735.

It is preferable that the melt viscosity of the thermoplastic film is higher than the melt viscosity of the at least one thermoplastic in the mixture heated in step a) by at least 10% and by at most 60%.

In another embodiment, the process of the invention comprises a step d) in which the mixture pressed in step b) is functionalized via injection to attach a further material, using at least one injection-molding polymer.

The functionalization per se is known to the person skilled in the art. It preferably consists in attachment of desired elements, for example attachment of ribs for stability and strength, assembly aids, map pockets and the like. These elements are obtained from the injection-molding polymer via injection to attach a further material onto the mixture pressed in step b).

Injection to attach a further material per se is likewise known to the person skilled in the art. This procedure preferably provides elements formed from injection-molding polymer to one or more regions of the surface of the continuous-fiber-reinforced thermoplastic. Suitable elements have already been defined above in the context of the term “functionalization”. For the purposes of the present invention, the method for injection to attach a further material is preferably carried out such that in step d) the injection-molding polymer is charged to free cavities present in the mold. These free cavities determine the specific shaping of the elements that are applied via injection to attach a further material onto the corresponding surface of the continuous-fiber-reinforced thermoplastic.

The injection-molding polymer per se used in step d) is known to the person skilled in the art. The injection-molding polymer is preferably a heat-resistant thermoplastic which is the same as the at least one thermoplastic comprised in the mixture, heated in step a), of the at least one fiber material and the at least one thermoplastic. All of the preferred polymers for the at least one thermoplastic accordingly are correspondingly valid to the injection-molding polymer used in step d).

The injection-molding polymer can moreover be modified in that it has been reinforced with at most 70% by weight, preferably at most 50% by weight, particularly preferably at most 30% by weight, based on the total weight of the injection-molding polymer, of material selected from glass fibers, carbon fibers, aramid fibers, natural fibers, glass spheres and mixtures thereof.

In anticipation of the possibility that the injection-molding polymer comprises reinforcement material, the free cavities which are present in the mold and to which the injection-molding polymer is charged can optionally likewise have a structured grain.

The injection-molding polymer used in step d) is generally molten when it is introduced into the mold in order to achieve functionalization via injection to attach a further material. It is preferable here that when the injection-molding polymer is introduced into the mold in step d) said polymer has been heated to a temperature of at least 160° C., preferably to a temperature of at least 250° C., particularly preferably to a temperature of at least 300° C.

The sequence (chronological sequence) in which the steps b), c) and d) are carried out is not strictly defined, but instead can be selected within the context of the following three options i), ii) and iii). In option i), step d) can be begun during step b). Equally, in option ii) step d) can be begun during step c) after step b) has ended, or in option iii) step d) is begun after step b) has ended and before step c). It is preferable that step d) is begun after step b) has ended and before step c).

The duration of the individual steps b), c) and/or d) is in principle freely selectable and known to the person skilled in the art. The individual steps b), c) and d) are generally continued until the desired result has been achieved. i.e. in step b) the pressing of the mixture heated in step a) has been concluded, and in step c) the cooling of the pressed mixture has been concluded, and in step d) provision of the injection-molding polymer to the surface of the fiber-reinforced thermoplastic at the locations intended for that purpose is complete.

After the pressing procedure in step b), the cooling in step c), and also optionally after the functionalization in step d), the continuous-fiber-reinforced thermoplastic can be removed from the mold.

The present invention also provides a thermoplastic having continuous-fiber reinforcement by a textile sheet and having a structured grain on the surface, and obtained via the process of the invention.

By virtue of the structured grain, continuous-fiber-reinforced thermoplastics produced by the process of the invention are suitable in visible components, for example in vehicles.

The present invention also provides the use of the thermoplastic having continuous-fiber reinforcement by a textile sheet and having a structured grain in visible components, preferably in visible components in vehicles.

1-14. (canceled)

15: A process for producing a structured grain on a surface of a thermoplastic having continuous-fiber reinforcement by a textile sheet, the process comprising:
a) heating a mixture of at least one fiber material and at least one thermoplastic to a temperature above a softening point of the at least one thermoplastic, where the at least one fiber material comprises continuous fibers and takes the form of a regularly arranged textile sheet,
b) pressing, in a mold, of the mixture heated in a), where a regularly arranged, structured grain has been applied on an internal side of the mold,
c) cooling, in the mold, of the mixture pressed in b) to a temperature below the softening point of the at least one thermoplastic, with formation of the structured grain on the surface of the thermoplastic having continuous-fiber reinforcement by the textile sheet,
where the structured grain on the internal side of the mold and the textile sheet in the mold have been oriented in relation to each other in b) in a manner such that the regularly arranged textile sheet and the regularly arranged, structured grain on the internal side of the mold are mutually superposed,
where the regularly arranged, structured grain is applied onto the internal side of the mold in a manner such that a structured grain is produced on a visible side of the continuous-fiber-reinforced thermoplastic, and
wherein the structured grain is produced in the mold via etching, laser-structuring, sandblasting, profile milling or erosion, as a result of which the internal side of the mold has a surface with depressions and/or elevations.

16: The process of claim 15, wherein the thermoplastic is a heat-resistant thermoplastic with a softening point above 100° C.

17: The process of claim 15, wherein
i) each of the at least one fiber material comprises at least 50% by weight of continuous fibers, based on a total weight of the at least one fiber material, and/or
ii) the regularly arranged textile sheet is a woven fiber fabric, laid fiber scrim, knitted fiber fabric or braided fiber fabric, or takes the form of a unidirectional or bidirectional fiber structure made of parallel fibers, and/or
iii) the at least one fiber material comprises glass fibers, natural fibers, aramid fibers, carbon fibers, metal fibers, polymer fibers, potassium titanate fibers, boron fibers or mineral fibers, and/or
iv) the mixture of the at least one fiber material and the at least one thermoplastic takes the form of a semifinished sheet.

18: The process of claim 15, wherein
i) the mixture of the at least one fiber material and the at least one thermoplastic is heated to a temperature above the softening point of the at least one thermoplastic in the mold in which b) is carried out, or
ii) the mixture of the at least one fiber material and the at least one thermoplastic is initially heated to a temperature above the softening point of the at least one thermoplastic in a separate device and is then transferred into the mold for the pressing according to b), or
iii) the mixture of the at least one fiber material and the at least one thermoplastic is initially preheated to a temperature below the softening point of the at least one thermoplastic in a separate device, then is transferred into the mold in which b) is carried out, and in the mold is heated to a temperature above the softening point of the at least one thermoplastic.

19: The process of claim 15, wherein
i) the at least one fiber material is saturated with the at least one thermoplastic to produce the mixture of the at least one fiber material and the at least one thermoplastic, or
ii) the at least one fiber material is saturated with monomers for the production of the at least one thermoplastic, and the monomers are then polymerized to produce the mixture of the at least one fiber material and the at least one thermoplastic.

20: The process of claim 15, wherein the pressing casts a shape of the structured grain on the internal side of the mold onto the surface of the thermoplastic having continuous-fiber reinforcement by the textile sheet.

21: The process of claim 15, wherein the structured grain on the internal side of the mold produces, on the surface of the thermoplastic having continuous-fiber reinforcement by the textile sheet, a structured grain in the form of a structuring pattern composed of at least one structure unit.

22: The process of claim 21, wherein
i) the structuring pattern of the structured grain on the surface of the continuous-fiber-reinforced thermoplastic comprises regularly arranged structure units having elevations, and/or
ii) the structuring pattern of the structured grain on the surface of the continuous-fiber-reinforced thermoplastic comprises regularly arranged structure units having depressions, and/or
iii) the structuring pattern of the structured grain on the surface of the continuous-fiber-reinforced thermoplastic comprises regularly arranged structure units having elevations and depressions.

23: The process of claim 21, wherein
i) a configuration of the structure units of at least two adjacent structuring patterns of the structured grain on the surface of the continuous-fiber-reinforced thermoplastic is such that an arrangement of all of the structure units of one of the at least two adjacent structuring patterns is inverted in relation to the structure units of another one of the at least two adjacent structuring patterns, and/or
ii) transitions between adjacent structuring patterns of the structured grain on the surface of the continuous-fiber-reinforced thermoplastic run through the structure units per se, and transitions between the structuring patterns are continuous, and/or
iii) transitions between adjacent structuring patterns of the structured grain on the surface of the continuous-fiber-reinforced thermoplastic run through the structure units per se, and, by virtue of an inversion of individual elements, transitions associated with each structuring pattern form a distinctly visible edge between the structuring patterns.

24: The process of claim 15, wherein the mixture of the at least one fiber material and the at least one thermoplastic comprises:
i) from 20 to 80% by volume of the at least one thermoplastic, and/or
ii) from 20 to 80% by volume of the at least one fiber material, and/or
iii) from 0 to 10% by volume of other additives,
where an entire volume of the mixture always provides 100% by volume.

25: The process of claim 15, wherein
i) before a), a thermoplastic film is applied to the mixture of the at least one fiber material and the at least one thermoplastic, and/or
ii) the thermoplastic film comprises the same thermoplastics as the mixture of the at least one fiber material and the at least one thermoplastic, and/or
iii) a melt viscosity of the thermoplastic film is higher by at least 10% and by at most 60% than a melt viscosity of the at least one thermoplastic in the mixture heated in a).

26: A thermoplastic having continuous-fiber reinforcement by a textile sheet and having a structured grain on the surface, obtainable by the process of claim 15.

27: A process of producing a visible component, the process comprising obtaining a thermoplastic having continuous-fiber reinforcement by a textile sheet and having a structured grain, obtainable by the process of claim 15.
